(19) United States
(12) Patent Application Publication
(10) Pub. No.: US 2007/0100468 A1
(43) Pub. Date: May 3, 2007

(54) Magnetic toy

(76) Inventor: Bong-Seok Yun, Kyounggi-Do (KR)

Correspondence Address: DeLio & Peterson, 121 Whitney Avenue, New Haven, CT, 06510, US

(21) Appl. No.: 10/477,432

(22) PCT Filed: Jun. 30, 2003
(86) PCT No.: PCT/KR03/01281

§ 371 Date: Dec. 5, 2005

(30) Foreign Application Priority Data
Jun. 20, 2003 (KR) 20-2003-0019589

(51) Int. Cl. G05B 15/00

(52) U.S. Cl. 700/1

(57) ABSTRACT

The object of this invention is to provide a magnetic toy, which is fabricated with magnetic rods and magnetic balls, and is freely shaped into a variety of forms. In the magnetic toy, each magnetic rod (31) is composed of a magnetic strand core (31A), a covering (31B) to cover the core (31A); a magnetic end disc (31C) placed at each end of the core (31A), and a disc-fastening cap (31D) which fastens the end disc (31C) to the core (31A). The disc-fastening cap (31D) includes an annular flange part (F) to support the end disc (31C), and a cylindrical part (B) integrated with the flange part (F) and screwed over each end of the covering (31B) so as to be fastened along with the disc (31C) to the covering (31B). A magnetic metal ball (32) is magnetically attached to each end of the magnetic rod (31).

### TECHNICAL FIELD

The present invention relates, in general, to magnetic toys, including magnetic rods and magnetic metal balls. More specifically, the present invention is directed to a magnetic toy, characterized in that a single metal strand or a wire twisted with a plurality of metal strands having magnetic properties is used as a core, which is covered with a covering made of a flexible synthetic resin material, after which a magnetic end disc is fastened to each end of the covered core, to form a magnetic rod, which can be freely shaped into various forms, such as straight-, bent-, or curved-types of lines, and assembled with other magnetic members, thus forming three-dimensional assembly structures.

### BACKGROUND ART

Typically representative of toys commercially available around the world, there are Lego products, functioning to increase the creativity of children who can play with them for long periods.

In the Lego products, a plurality of components having various shapes can be assembled into various structures, depending on respective tastes and ideas of children. Thus, the Lego products are considered as toys helping imaginative power and creativity of children improve, and as well, are formed to be different in number and size of components while a size ratio of the components is regularly controlled according to age, whereby children may play with the Lego products until becoming teenagers.

However, limitations are imposed on the Lego products, because of requiring specific shapes of components to build specific assembly structures. In addition, each component of the Lego products comprises three-dimensional shapes based on cuboids or cubes. Hence, if a child has Lego sets based on several playing themes, the total assembly components thereof occupy a large storage space. Further, since a time need for finding a desired component among many mixed components becomes longer, there is further required a prolonged period to make a specific assembly structure.

To solve the disadvantages of the Lego products, magnetic toys are developed, which serve to increase the creativity of children by allowing them to plan new geometric assembly designs and build them, without relying on basic assembly designs concerning specific themes.

In general, the magnetic toy is composed of magnetic rods each covered with a synthetic resin covering and each having a metal bar and a magnetic end disc placed at each end of the metal bar, and metal balls. A plurality of the metal rods are continuously connected by means of the magnetic balls, thereby forming desired assembly models or structures.

That is, various assembly models having three-dimensional structures can be formed by combining the magnetic rods and the metal balls. Hence, children play with the magnetic toy, whereby they can enhance their spatial sense, creativity and understanding of geometric assembly structures.

A representative magnetic toy is schematically shown in FIGS. 1 and 2A and 2B.

FIG. 1 is a perspective view of a conventional magnetic toy when being practically used. Also, FIGS. 2A and 2B illustrate a magnetic rod constituting the conventional magnetic toy of FIG. 1 and a basic assembly structure thereof, respectively.

As shown in the drawings, the conventional magnetic toy includes a plurality of magnetic rods 1 and a plurality of metal balls 2, in which each magnetic rod 1 is composed of a metal bar 12, a magnetic end disc 11 placed at each end of the metal bar 12, and a covering 13 made of a synthetic resin to cover the metal bar 12, and an outside surface and an edge of an external end S of the end disc 11. By means of each of the metal balls 2, a plurality of the magnetic rods 1 are connected. In the magnetic rod 1, the magnetic end disc 11 is placed at each end of the metal bar 12, whereby the magnetic rod 1 can function as a cylindrical magnet having a circular section, thus representing N-polarity at one end of the magnetic rod 1 and S-polarity at the other end thereof.

Each end of the magnetic rod 1 is attached to the metal ball 2 by magnetic force. As such, a connected structure is basically represented by a triangular shape. Based on such a shape, larger and more complicated assembly structures are completed.

The magnetic end disc 11, which acts to decrease size and weight of final magnetic products by retaining high performance magnetic properties, is formed with rare earth-based neodymium (Nd) having superior mechanical strength and corrosion resistance. The end disc 11 is attached to each end of the metal bar 12 to induce dense lines of magnetic force, resulting in magnetic force enhancement of about 1000 G. By the enhanced magnetic force, any assembly structure having a plurality of the magnetic rods 1 and a plurality of the metal balls 2 connected together can be firmly maintained.

The conventional magnetic toy is advantageous in terms of minimized storage space requirement, owing to including the metal balls and the magnetic rods. In addition, since the magnetic end disc 11 is used to connect the magnetic rods and balls, there is no anxiety over the loss of individual magnetic rods and metal balls. As such, the conventional magnetic toy is suitable for building geometric models comprising joints and lines, but unsuitable for assembling complicated structures having curved shapes, such as circular shapes.

Therefore, there are further required circular arc-type magnetic rods and magnetic rods bent at various angles and length ratios, as well as straight line-type magnetic rods. However, the conventional magnetic toy does not meet the above requirements, and suffers from allowing preparation of only relatively simple assembly structures.

To solve the problems concerned with the conventional magnetic toy, Korean Utility Model Application Nos. 02-35767 and 20-26771 disclose magnetic toys.

In the magnetic toy disclosed in Korean Utility Model Application No. 02-35767, a metal ball is positioned between metal pins (corresponding to the metal bar), and a magnetic end disc is attached to each end of two metal pins connected together, after which two metal pins and the metal ball along with an edge of the end disc are covered with a covering made of a synthetic resin material. Thereby, the covered magnetic rod is bendable centering on the metal ball. Since the magnetic rod is properly bendable at predetermined angles, variously shaped structures can result. However, the above magnetic toy is disadvantageous in that it is difficult to change the magnetic rods into circular arc shapes.

Additionally, the magnetic toy disclosed in Korean Utility Model Application No. 20-26771 (title: playing toy) is characterized in that a plurality of magnetic rods are made to form various shapes, including semicircular-types, ¼ circular-types, or shapes bent at right angles or obtuse angles, thereby obtaining more various shapes of structures. However, due to many magnetic rods having the above various shapes, a time required for selecting proper magnetic rods is increased, resulting in prolonged assembling periods of desired structures. Attributed to the preparation of magnetic rods having various shapes, productivity is also reduced.

Moreover, since all possible shapes of magnetic rods cannot be prepared, the assembly structures have limited shapes even though being various. Further, the constructed structures depend only on the shapes of the mass-produced magnetic rods.

### DISCLOSURE OF THE INVENTION

Accordingly, the present invention has been made keeping in mind the above problems occurring in the related art, and an object of the present invention is to provide a magnetic toy including a plurality of magnetic rods and a plurality of metal balls, characterized in that each of the magnetic rods can be freely shaped to have various forms, such as bent-types each having various angles and length ratios, curved-types, or combinations thereof, provided that each magnetic rod has a basic shape of a straight line, whereby almost all possible shapes of assembly structures can be constructed even while kinds of the magnetic rods are minimized.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a conventional magnetic toy when being practically used;

FIGS. 2A and 2B are sectional views of a magnetic rod for use in the conventional magnetic toy of FIG. 1 and a basic assembly structure of the magnetic toy, respectively;

FIG. 3 is a perspective view of a magnetic toy according to a first embodiment of the present invention;

FIG. 4 is a sectional view of the magnetic toy of FIG. 3;

FIG. 5 is a perspective view of a core, suitable for use in a magnetic rod of a magnetic toy according to a second embodiment of the present invention;

FIGS. 6A and 6B are a perspective view and a sectional view of a disc-fastening cap of the magnetic rod of the magnetic toy of FIG. 3, respectively;

FIG. 7 is a sectional view of a magnetic rod of a magnetic toy according to a third embodiment of the present invention;

FIGS. 8A and 8B are a perspective view and a sectional view of a core-fastening cap of the magnetic rod of FIG. 7, respectively;

FIG. 9 is a front view of variously shaped forms of the magnetic rods of the present invention having the same length;

FIGS. 10A and 10B are front views of magnetic rods of the present invention having different lengths and variously shaped forms thereof, respectively; and

FIG. 11 is a perspective view of a magnetic rod of a magnetic toy according to a fourth embodiment of the present invention.

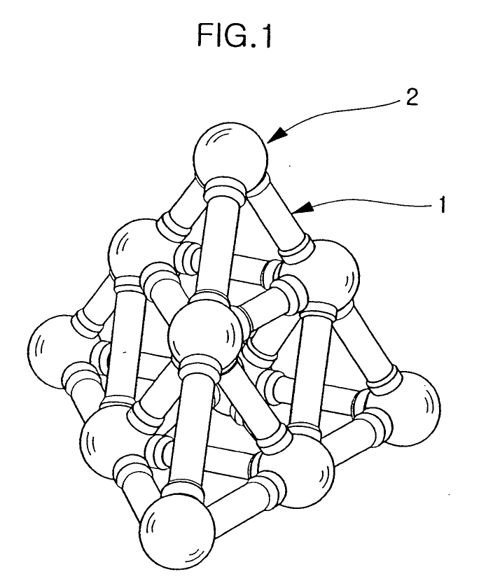

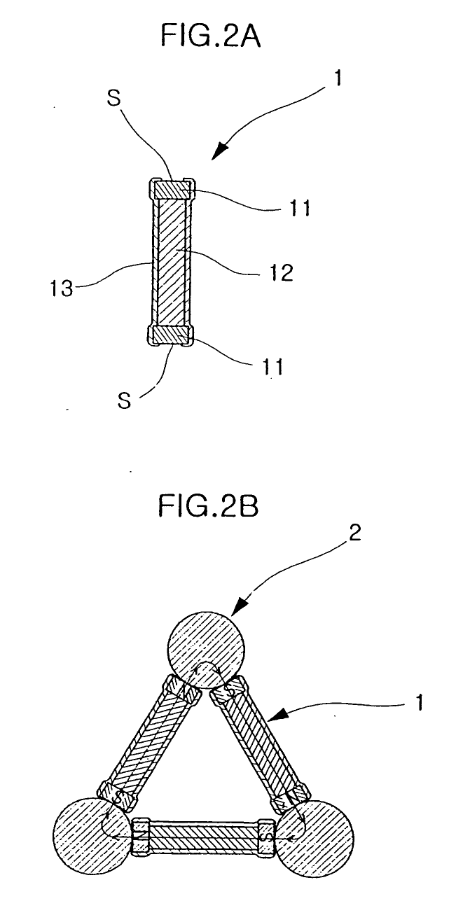

### BEST MODE FOR CARRYING OUT THE INVENTION

Based on the present invention, a magnetic toy includes a plurality of magnetic rods and a plurality of metal balls, characterized in that each of the magnetic rods can be freely shaped to have various forms and restored to their original state.

In the magnetic toy, each magnetic rod has a magnetic strand core made of a metal material with magnetic properties which is subjected to repeated plastic deformation, a covering made of a synthetic resin having flexible properties, such as PVC (PolyVinyl Chloride), PP (PolyPropylene) or urethane, to cover the magnetic strand core, and a magnetic end disc fastened to each end of the core. By the magnetic metal strand core and the flexible covering, the magnetic rod can be freely shaped into a variety of forms, for example, curved-types, such as circular- or semicircular-types, and bent-types having various angles and length ratios.

To ensure plastic deformation of the magnetic metal strand core, prevalently used is a wire formed of a carbon steel having not more than 0.2 wt % carbon or pure iron containing carbon as an impurity. Otherwise, use is made of a metal strand with magnetic properties while having strength and ductility equivalent to the above wire. Of carbon steels, low carbon steel is more preferably used, exemplified by SAE1006 having carbon not more than 0.08 wt %, which is allowed for the Automobile Society, USA.

However, if the core includes carbon exceeding 0.2 wt %, it is difficult to freely shape the core, due to high resistance to plastic deformation, therefore resulting in breakage of the core upon repeated deformation. Thereby, a magnetic force is not transferred from one magnetic end disc to the other magnetic end disc, thus decreasing a total magnetic force of the magnetic rod.

In cases where the metal strand is used as the core, resistance to deformation is enhanced as a diameter of the strand becomes thicker. Hence, instead of a single metal strand having a large diameter, a plurality of metal strands each having a small diameter are twisted and used. When the twisted strands (hereinafter, ‘wire’ means a plurality of twisted metal strands, and ‘metal strand’ means a single strand) are used, a covering material is intercalated into the metal strands. At this time, a binding force is expected to increase between the wire used as the core and the covering.

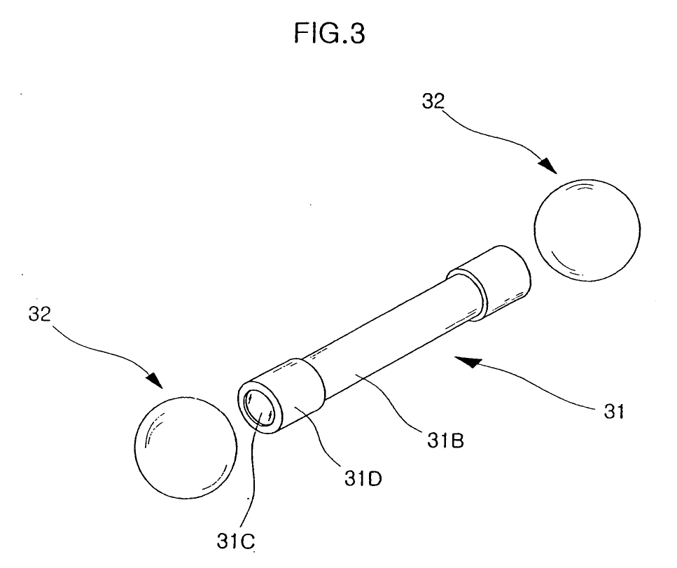

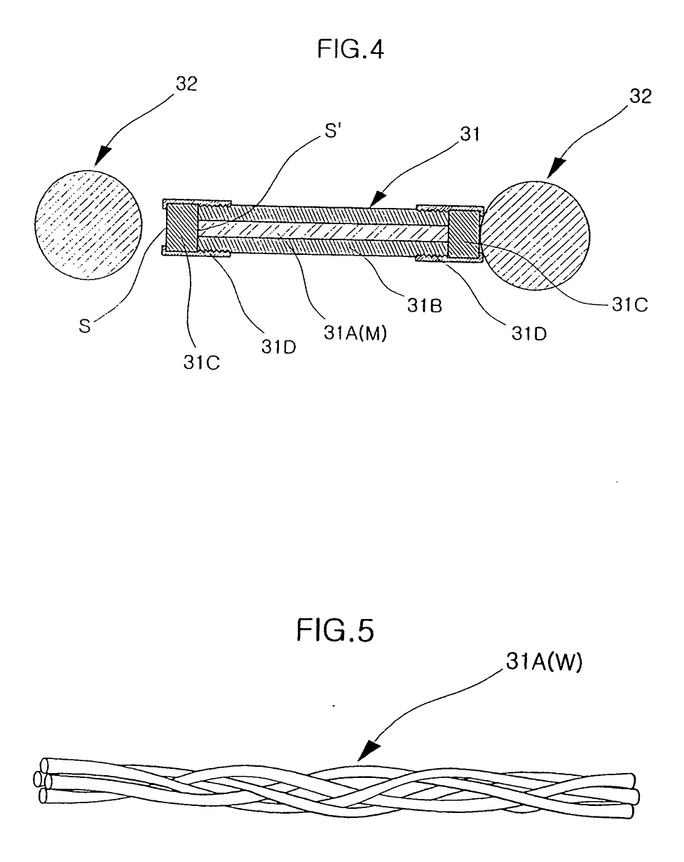

Referring to FIGS. 3 and 4, a magnetic toy according to a first embodiment of the present invention is shown in a perspective view and a sectional view, respectively. FIG. 5 is a perspective view of a wire for use in a magnetic rod of a magnetic toy according to a second embodiment of the present invention.

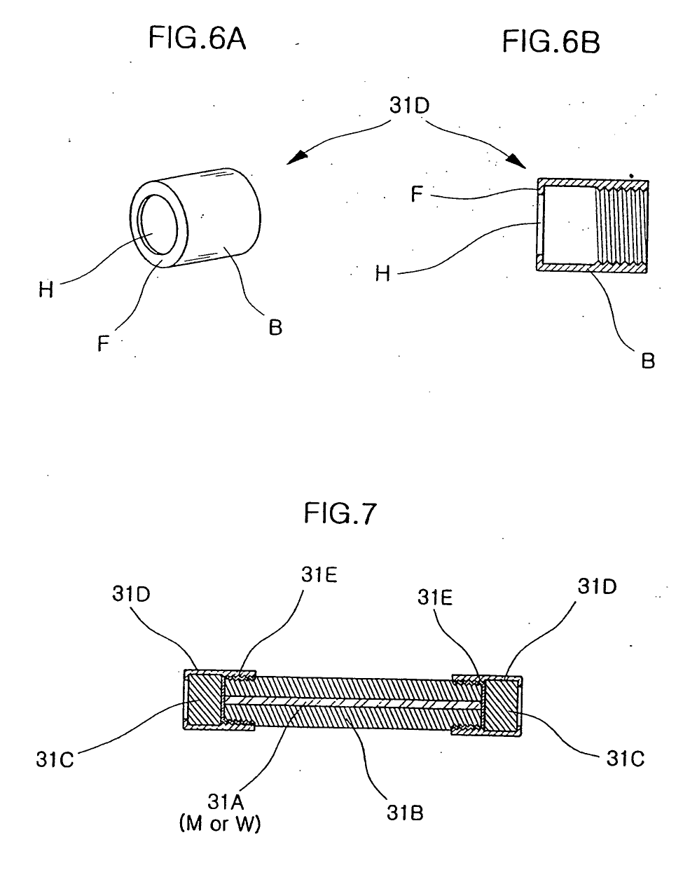

As shown in the drawings, the magnetic toy includes a plurality of magnetic rods 31 and a plurality of magnetic metal balls 32. In the magnetic toy, each magnetic rod 31 is composed of a magnetic metal strand core 31A capable of being subjected to repeated plastic deformation, a covering 31B made of a synthetic resin to cover an outside surface of the core 31A with the exception of each end of the core 31A, a magnetic end disc 31C placed at each end of the core 31A covered with the covering 31B, and a disc-fastening cap 31D. The disc-fastening cap 31D is specifically shown in FIGS. 6A and 6B, including a through-hole H formed at a central portion thereof to expose a center of an external end S of the magnetic end disc 31C, an annular flange part F placed at an edge of the external end S of the end disc 31C to support the end disc 31C, and a cylindrical part B integrally extending from an edge of the flange part F so as to be fastened along with the end disc 31C to each end of the covering 31B. Each of the magnetic metal balls 32 is magnetically attached to each end of the magnetic rod 31, by means of the end disc 31C of the magnetic rod 31.

As such, the core 31A is formed with a single metal strand M or a wire W twisted with a plurality of metal strands.

Although each end of the covering 31B may be adhered to the inside surface of the cylindrical part B of the disc-fastening cap 31D by use of an adhesive, durability of the adhesive may decrease over time. After all, due to shearing force at contact surfaces by repeated plastic deformation, the covering 31B is separated from the disc-fastening cap 31D. To alleviate the above problem, in the state of each end of the core 31A covered with the covering 31B being fitted into the cylindrical part B of the disc-fastening cap 31D, the outside surface of the cylindrical part B is partially compressed to the covering 31B, whereby the cylindrical part B bites the covering 31B. Otherwise, an outside surface of each end of the covering 31B and an inside surface of the cylindrical part B of the disc-fastening cap 31D are threaded to allow the disc-fastening cap 31D to be screwed over each end of the covering 31B. Thereby, a fastening force increases between the covering 31B and the disc-fastening cap 31D, while the magnetic end disc 31C is detachably disposed therebetween.

Further, in the magnetic toy, the core 31A is separated from the covering 31B at a boundary therebetween attributed to the shearing force upon the repeated plastic deformation of the magnetic rod 31. Hence, the core 31A may be moved to one side with respect to the covering 31B, or each end of the core 31A may be inclined with respect to the magnetic end disc 31C, whereby each end of the core 31A is detached from an internal end S′ of the end disc 31C or contact areas between each end of the core 31A and the end disc 31C are decreased, thus drastically reducing a magnetic force of the magnetic rod 31.

Accordingly, in a magnetic rod of a magnetic toy according to a third embodiment of the present invention, a core-fastening cap 31E is preferably used between a magnetic end disc 31C and a magnetic strand core 31A.

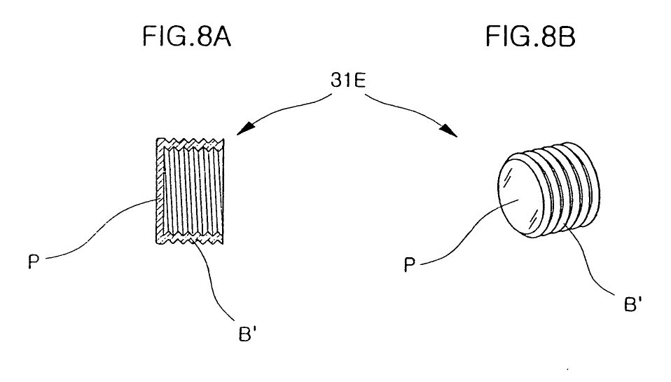

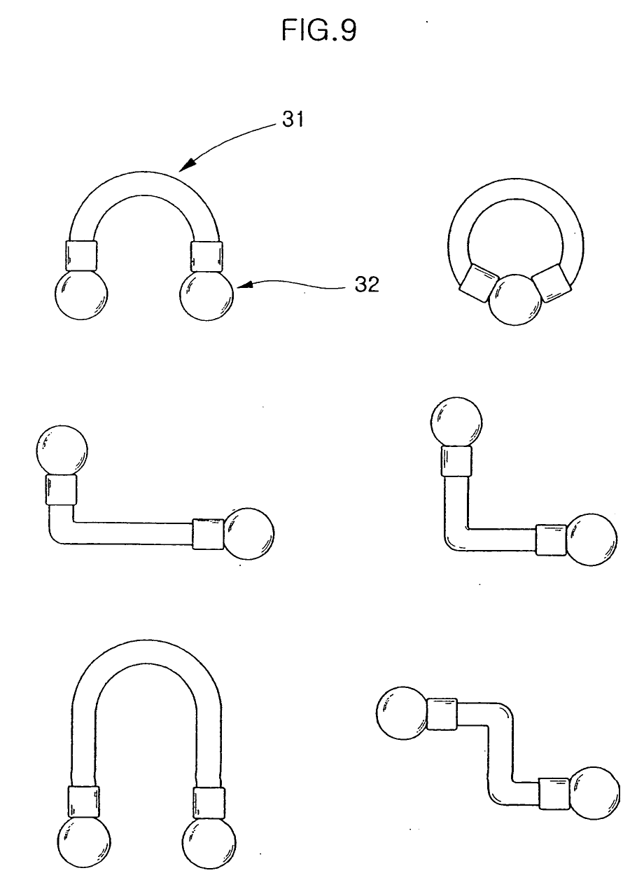

As shown in FIGS. 7 and 8A and 8B, the core-fastening cap 31E includes a disc part P, and a second cylindrical part B′ integrally extending from the disc part P and threaded on both inside and outside surfaces thereof. Into thusly formed core-fastening cap 31E, each end of the core 31A covered with a covering 31B is fitted.

Before the covered core 31A is fastened to the core-fastening cap 31E, the cap 31E is in the state of not being threaded. Hence, each end of the covered core 31A is fitted into the core-fastening cap 31E, after which the cylindrical part B′ of the core-fastening cap 31E is compressed. Thereby, the cylindrical part B′ is threaded on the inside and outside surfaces thereof. That is, since the cylindrical part B′ is compressed to be threaded in the state of being fastened to the core 31A, the inside surface of the cylindrical part B′ is more firmly fastened to the outside surface of the covering 31B. Simultaneously, valleys in the outside surface or ridges on the inside surface of the cylindrical part B′ of the core-fastening cap 31E bite the outside surface of the covering 31B, so that the core-fastening cap 31E is more securely fastened to the covering 31B.

In addition, an internal end of the disc part P of the core-fastening cap 31E is fastened to each end of the core 31A by means of a resistance welding process. Thus, the disc part P is not separated from the core 31A even by any plastic deformation of the magnetic rod 31. Also, after the magnetic end disc 31C is placed at an external end of the disc part P, the threaded inside surface of the disc-fastening cap 31D is screwed on the outside surface of the cylindrical part B′ of the core-fastening cap 31E.

In the magnetic rod 31, the metal strand or the wire, which can be repeatedly subjected to flexible plastic deformation, is used as the core. As shown in FIG. 9, the magnetic rod 31 may be freely shaped into various forms, such as semicircular-, circular-, bent-, curved-, and straight line-types. Consequently, desired assembly structures having a variety of shapes may result.

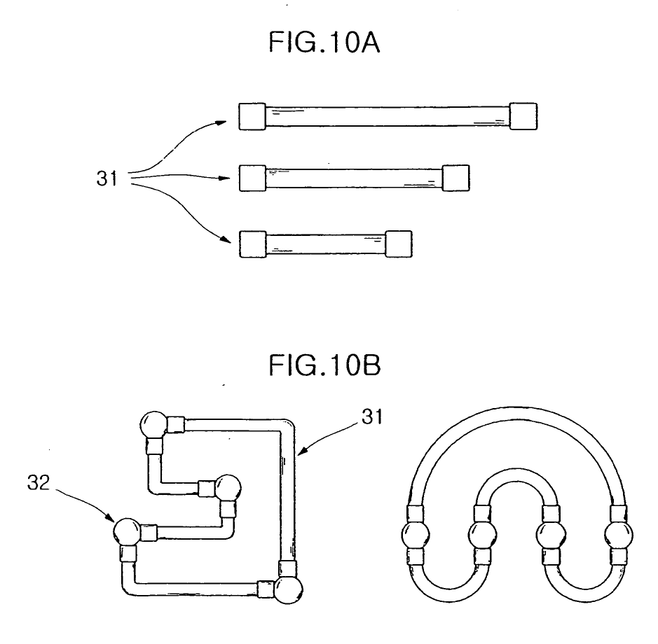

The magnetic rod constituting the magnetic toy of the present invention is basically made to a straight line-type. Since the rod per se is flexible, it can be freely shaped into desired forms. That is, if there are only the straight line-type magnetic rods having different lengths, most structures having complicated shapes may be assembled, as apparent from FIGS. 10A and 10B.

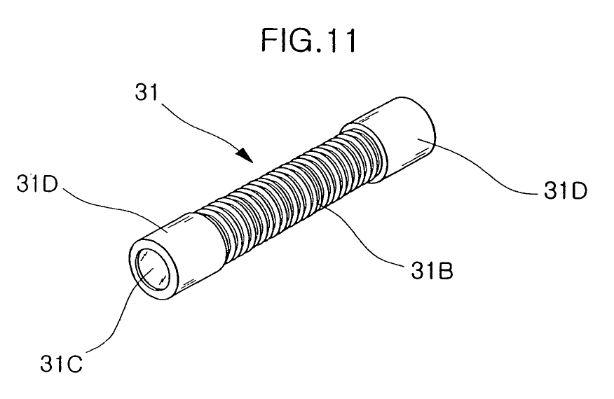

Turning now to FIG. 11, there is shown a magnetic rod of a magnetic toy according to a fourth embodiment of the present invention, in which a covering 31B of the magnetic rod has a plurality of annular grooves that are formed along an axial direction of the covering 31B to improve plastic deformability of the covering 31B as well as the core 31A.

### INDUSTRIAL APPLICABILITY

As described above, the present invention provides a magnetic toy, including a plurality of magnetic rods and a plurality of magnetic metal balls. Each of the magnetic rods is subjected to repeated plastic deformation, and various assembly structures, which are difficult to build by conventional toys, can result, so as to arouse interest of children. In addition, since the magnetic rod per se can be freely shaped into diverse forms, there are required few magnetic rods having different shapes, thus increasing productivity and reducing preparation costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A magnetic toy, comprising a plurality of magnetic rods and a plurality of magnetic metal balls,
wherein each of the magnetic rods includes
a magnetic strand core made of a flexible metal material,
a covering made of a synthetic resin to cover the core, with the exception of each end of the core,
a magnetic end disc placed at each end of the core, and
a disc-fastening cap which fastens the magnetic end disc to the core, having a through-hole formed at a central portion thereof, an annular flange part placed at an edge of an external end of the magnetic end disc to support the magnetic end disc, and a cylindrical part integrally extending from an edge of the annular flange part so as to be fastened along with the end disc to each end of the covering; and
each of the magnetic metal balls is magnetically attached to each end of the magnetic rod.

2. The magnetic toy according to claim 1, wherein the core comprises a single metal strand or a wire twisted with a plurality of metal strands.

3. The magnetic toy according to claim 1, wherein the core comprises a carbon steel having not more than 0.2 wt % carbon, or pure iron having carbon as an impurity.

4. The magnetic toy according to claim 1, wherein the synthetic resin for use in the covering comprises polyvinyl chloride, polypropylene, or urethane.

5. The magnetic toy according to claim 1, wherein an outside surface of each end of the covering and an inside surface of the disc-fastening cap are threaded to allow the disc-fastening cap to be screwed over each end of the covering.

6. The magnetic toy according to claim 1, wherein an outside surface of the covering has a plurality of annular grooves which are formed along an axial direction of the covering.

7. The magnetic toy according to claim 1, further comprising a core-fastening cap between each end of the core covered with the covering and the magnetic end disc, the core-fastening cap including a disc part placed at each end of the core, and a second cylindrical part integrally extending from the disc part and threaded on both inside and outside surfaces thereof so as to be fastened to an outside surface of each end of the covering.
